(19) United States
(12) Patent Application Publication
(10) Pub. No.: US 2025/0164864 A1
(43) Pub. Date: May 22, 2025

(54) FOLDABLE MOUNTING DEVICE AND METHOD OF OPERATING THE SAME

(71) Applicant: Shenzhen Leqi Innovation Co., Ltd., Shenzhen (CN)

(72) Inventors: Qiang LIN, Shenzhen (CN); Jiawei XU, Shenzhen (CN)

(73) Assignee: Shenzhen Leqi Innovation Co., Ltd., Shenzhen (CN)

(21) Appl. No.: 19/033,507

(22) Filed: Jan. 22, 2025

Related U.S. Application Data
(63) Continuation-in-part of application No. PCT/CN2023/100780, filed on Jun. 16, 2023.
(63) Continuation-in-part of application No. PCT/CN2023/111295, filed on Aug. 4, 2023.

(30) Foreign Application Priority Data
Aug. 5, 2022 (CN) 202210942160.2
Dec. 2, 2022 (CN) 202223260587.9

(51) Int. Cl. G03B 17/56

(52) U.S. Cl. CPC G03B 17/561

(57) ABSTRACT

A foldable mounting device for a photographing device includes a base plate, a side plate, and a locking member. The base plate includes a connecting end defining an accommodation slot and a connecting opening. The connecting opening passes through a side of the base plate, the accommodation slot includes a slot opening passing through another side of the base plate. The side plate is connected to the connecting end. The locking member slidably received in the accommodation slot includes a locking part and an operation part. The operation part is received in the slot opening. The locking member is operatable to move from a locked state in which the locking part passes through the connecting opening to engage with the side plate to an unlocked state in which the locking part is disengaged from the side plate and the side plate is rotatable relative to the base plate.

### FIELD

The present invention relates to the technical field of photographing equipment, in particular to a foldable mounting device for a photographing device and a method of operating the foldable mounting device.

### BACKGROUND

A camera gimbal quick-release plate is a commonly used photographic accessory which is configured to mount and secure a camera or a video camera in order to facilitate photography or filming. For example, an L-shaped quick-release plate with a base plate and a side plate perpendicular to each other, can be mounted on a tripod or stabilizer through a camera gimbal. An existing L-shaped quick-release plate usually has rails with dovetail grooves formed on both the base plate and the side plate. The camera gimbal can selectively connect with one of the base plate and the side plate to achieve quick switching between a horizontal shooting mode and a vertical shooting mode. However, for photographic equipment with foldable screens, such as cameras and monitors, after the screen is opened horizontally the screen can be rotated around an axis to meet the shooting needs. Therefore, during the process of horizontally shooting, when the camera's foldable screen is opened, it will interfere with the side plate of the L-shaped quick-release plate. Typically, an L-plate with a base plate rotatable relative to the side plate is used. However, tools are usually needed in order to unlock or lock the existing rotation structure. Thus, the operation of the existing rotation structure is troublesome and it is suitable for quick operation.

### SUMMARY

It is desired to provide an improved foldable mounting device for a photographing device and a method of operating the foldable mounting device.

In one aspect, the present invention provides a foldable mounting device applicable for a photographing device. The foldable mounting device includes a base plate comprising a free end and a connecting end opposite to each other, the connecting end comprising an accommodation slot and a connecting opening, the connecting opening passing through a side of the base plate, the accommodation slot comprising a slot opening which passes through another side of the base plate; a side plate connected to the connecting end of the base plate; and a locking member slidably received in the accommodation slot, the locking member comprising a locking part and an operation part, the operation part being received in the slot opening and exposed from said another side of the base plate. The locking member is operatable via the operation part to move from a locked state in which the locking part passes through the connecting opening to engage with the side plate such that the side plate is locked and nonrotatable relative to the base plate to an unlocked state in which the locking part is disengaged from the side plate such that the side plate is rotatable relative to the base plate.

In some embodiments, the foldable mounting device further comprises a restoring member which is connected between the locking member and the base plate and configured to return the locking member from the unlocked state to the locked state.

In some embodiments, the locking member further comprises a body which comprises at least one biasing surface and at least one recess formed at a side thereof facing the side plate, the at least one recess comprising a guide surface and a stop surface opposite to the guide surface; the locking part comprises at least one sliding component which is movably received in the accommodation slot and disposed between the side plate and the locking member. When the locking member is located in the locked position the at least one sliding component is compressed between the side plate and the at least one biasing surface; and when the locking member is located in the unlocked position the at least one sliding component is slid into the at least one recess along the guiding surface and disengaged from the side plate.

In some embodiments, the guide surface is longer than the stop surface; and/or the stop surface is steeper than the guide surface.

In some embodiments, the side plate comprises a rotation connecting part connected to the base plate, the rotation connecting part comprises at least one positioning opening formed in an outer surface thereof for engaging with the locking part when the locking member is located in the locked state.

In some embodiments, the at least one positioning opening comprises multiple positioning holes distributed at interval in a rotation direction of the side plate.

In some embodiments, the at least one positioning opening comprises multiple positioning slots in communication with each other.

In some embodiments, the locking part comprises at least one ball and the at least one positioning opening comprises multiple positioning holes each of which has a shape matching with the at least one ball.

In some embodiments, the at least one positioning opening comprises at least one first positioning opening and at least one second positioning opening. When the locking part is engaged in the at least one first positioning opening, the side plate is located in a folded state in which the side plate is folded on the base plate; and when the locking part is engaged in the at least one second positioning opening, the side plate is located in an unfolded state in which a preset angle is formed between the side plate and the base plate.

In some embodiments, the locking part comprises multiple balls, a number of the balls is equal to that of the at least one first positioning opening, and the number of the balls is equal to that of the at least one second positioning opening.

In some embodiments, the connecting end of the base plate comprises a receiving space and a pair of first connecting parts located at opposite sides of the receiving space; the receiving space is spaced from the accommodation slot in a length direction of the base plate; the connecting opening communicates the receiving space with the accommodation slot; the body is slidable in the accommodation slot in a width direction of the base plate which is perpendicular to the length direction; and the rotation connecting part is pivotably received in the receiving space via a shaft which pivotably connects the rotation connecting part to the first connecting parts. The locking part is movable in the connecting opening in the length direction, and the locking part is movable in the connecting opening in the width direction.

In some embodiments, the locking member further comprises an elongated body, the operation part is located at an end of the elongated body opposite to the restoring member, and a step is formed at a joint between the operation part and the elongated body; a stop wall is formed at a joint between the accommodation slot and the slot opening for limiting an inwardly moving range of the operation part; and a limiting structure is formed between the elongated body and the accommodation slot for limiting an outwardly moving range of the operation part.

In some embodiments, the foldable mounting device further comprises a retaining member configured for maintaining a free end of the side plate being overlapped on the base plate and stopping the side plate from moving from a folded position to an unfolded position randomly.

In some embodiments, the retaining member is pivotably connected to the base plate; the retaining member comprises a hook, and the free end of the side plate comprises a locking rod. When the side plate is located in the folded position the hook catches the locking rod to thereby maintain the free end of the side plate being overlapped on the base plate.

In some embodiments, the free end of the side plate comprises a locking rod; the retaining member comprises a hook member and an engaging member which are both movably connected to the base plate; the hook member comprises a hook groove with a groove opening, the hook member being moveable between an initial position and a holding position. When the engaging member engages with the hook member to maintain the hook member in the initial position, the side plate can be rotated to cause the locking rod to enter in the hook groove from the groove opening of the hook groove; and after the engaging member releases the hook member to allow the hook member to move to the holding position, the groove opening of the second groove is offset from the locking rod, whereby the locking rod being locked in the hook groove.

In some embodiments, the base plate comprises a first receiving slot and a second receiving slot defined in a bottom surface thereof, the first receiving slot and the second receiving slot being in communication with each other; the hook member is slidably received in the first receiving slot, and the engaging member is slidably received in the second receiving slot; one end of the hook member is located outside the base plate for facilitating operation; and the sliding directions of the hook member and the engaging member are different from each other.

In some embodiments, the hook member comprises a positioning opening defined at a side thereof facing the engaging member; the side plate comprises a pushing part, and the base plate comprises a third receiving slot communicating with the first receiving slot and the second receiving slot. When the hook member is in the initial position, the engaging member partially extends into the third receiving slot and an end of the engaging member is engaged in the positioning opening. When the locking rod enters the hook groove, the pushing part enters the third receiving slot to push the engaging member to move in a direction away from the hook member such that the end of the engaging member is disengaged from the positioning opening.

In some embodiments, the side plate comprises a first pair of wings formed on opposite sides of one surface thereof and a second pair of wings formed on opposite sides of another surface thereof such that a holding device of the photographic equipment can selectively engage with one of the first pair of wings and the second pair of wings.

In another aspect, the present invention further provides a method for operating the foldable mounting device described above. The method comprises pushing the locking member from the locked state to the unlocked state to cause the locking part of the locking member to release the side plate; rotating the side plate relative to the base plate to a predetermined position such that a preset angle is formed between the side plate and the base plate; and returning the locking member from the unlocked state to the locked state.

In some embodiments, the method further comprises mounting the photographing device on the base plate; and securing a holding device of the photographing device with the side plate.

### BRIEF DESCRIPTION OF THE DRAWINGS

FIG. 1 is a perspective view of a foldable mounting device according to an embodiment of the invention;

FIG. 2 is an exploded view of FIG. 1, with a side plate of the foldable mounting device being removed;

FIG. 3 is an enlarged view of an encircle part A of FIG. 2;

FIG. 4 is an enlarged view of an encircle part B of FIG. 2;

FIG. 5 is a cross-sectional view of FIG. 1;

FIG. 5A is an enlarged view of an encircle part S of FIG. 5;

FIG. 6 illustrates a body and an operation part of a locking member according to an alternative embodiment of the present invention;

FIG. 6A is a cross-sectional view showing the locking member of FIG. 6 assembled in the accommodate slot of the base plate;

FIG. 7 is a perspective view of the side plate of the foldable mounting device as shown in FIG. 1;

FIG. 8 is a cross-sectional view of FIG. 7;

FIG. 9 illustrates the side plate being folded and locked on the base plate of the foldable mounting device;

FIG. 10 illustrates a retaining member according to an embodiment of the present invention;

FIG. 11 is a perspective view of a foldable mounting device according to an alternative embodiment of the invention;

FIG. 12 is similar to FIG. 1 but viewed from another aspect;

FIG. 13 illustrates the side plate of the foldable mounting device as shown in FIG. 11;

FIG. 14 illustrates a part of the base plate of the foldable mounting device as shown in FIG. 11;

FIG. 15 illustrates a retaining member according to an alternative embodiment of the present invention;

FIG. 16 illustrates a hook member of the retaining member as shown in FIG. 15;

FIG. 17 is a perspective view of a foldable mounting device according to a further alternative embodiment of the invention;

FIG. 18 is an exploded view of FIG. 17;

FIG. 19 is a horizontal cross-sectional view of FIG. 17;

FIG. 20 is a vertical cross-sectional view of FIG. 17;

FIG. 21 illustrates the side plate of the foldable mounting device as shown in FIG. 17;

FIG. 22 illustrates the side plate being folded and locked on the base plate of the foldable mounting device as shown in FIG. 17; and

FIG. 23 illustrate a method of operating a foldable mounting device in accordance with an embodiment of the present invention.

### DESCRIPTION OF THE EMBODIMENTS

The technical solutions in the embodiments of the invention will be clearly and completely described below in conjunction with accompanying drawings of these embodiments. Obviously, the embodiments in the following description are merely illustrative ones and are not all possible ones of the invention. All other embodiments obtained by those ordinarily skilled in the art according to the following ones without creative labor should also fall within the protection scope of the invention.

It should be noted that all directional indications (such as “upper”, “lower”, “left”, “right”, “front” and “back”) in the embodiments of the invention are merely used to explain relative positional relations and motions between components in a specific attitude (as shown below), and once the specific attitude changes, these directional indications will change accordingly.

It should also be noted that when one element is referred to as being “fixed to” or “arranged on” the other element, it may be “fixed to” or “arranged on” the other element directly or by means of an intermediate element. When one element is referred to as being “connect to” the other element, it may be connected to the other element directly or by means of an intermediate element.

In addition, descriptions such as “first” and “second” involved in the invention are merely for a purpose of description, and should not be construed as indicating or implying relative importance or implicitly indicating the number of technical features referred to. Therefore, a feature defined by “first” or “second” may explicitly or implicitly indicate the inclusion of at least one said feature. In addition, the term “and/or” used throughout the application implies the inclusion of three options. For example, “option A and/or option B” includes option A alone, option B alone, and option A and option B being satisfied simultaneously. In addition, the technical solutions in the embodiments may be combined as long as it can be implemented by those skilled in the art. In a case where a combination of the technical solutions is contradictory or cannot be implemented, the combination should be construed as non-existent and will not fall within the protection scope of the invention.

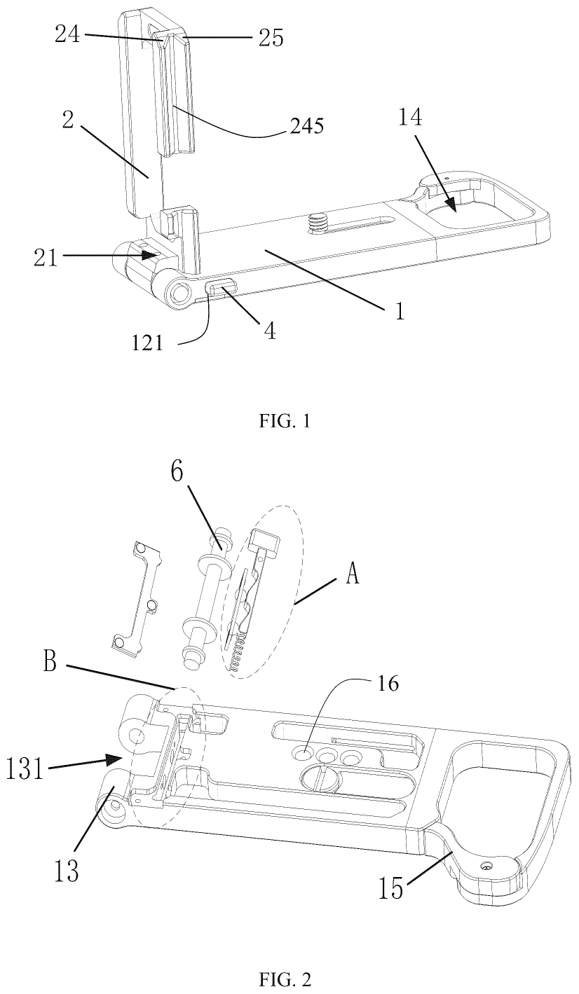

The present disclosure provides a foldable mounting device for photographic equipment. As shown in FIGS. 1 to 4, the foldable mounting device includes a base plate 1, a side plate 2 and a locking member 4. The base plate 1 is configured for detachably mounting the photographic equipment thereon. The base plate 1 comprises a connecting end and a free end opposite to the connecting end. The connecting end defines an accommodation slot 12. A connecting opening 11 is defined in the side of the accommodation slot 12 that is opposite to the free end. A slot opening 121 communicating with the accommodation slot 12 is defined in another side surface of the base plate 1. The side plate 2 is rotatably connected to the connecting end of the base plate 1. In this embodiment, the locking member 4 comprises a body 42, an operation part 43 and a locking part 44. The operation part 43 is formed at one end of the body 42. The body 42 is slidably received in the accommodation slot 12 from the slot opening 121. The body 42 is slidable along the rotating axial direction of the side plate 2 around which the side plate 2 is rotatable. The body 42 has a biasing surface 422 on the side close to the side plate 2. The locking part 44 is slidably arranged in the connecting opening 11 and located between the body 42 and the side plate 2. Thus, the locking part 44 can also be named as a sliding component 44. The foldable mounting device has an unlocked state and a locked state where the biasing surface 422 of the locking member 4 abuts against the sliding component 44 and the sliding component 44 passes through the connecting opening 11 to push against the side plate 2. The slot opening is communicated with outside to expose the locking member 4 such that the locking member 4 can be operated by users.

In the present invention, the photographic equipment includes electronic devices with photography and/or videography functions, such as cameras, video cameras, camcorders, stabilizers, smartphones, etc. A camera will be taken as an example. The camera can be securely fastened to the upper surface of the base plate 1 via a fastener such as a screw. Both the side plate 2 and the base plate 1 protect the camera. Various photography accessories such as adapters, expansion plates, quick-release components, stands, microphones etc are often needed for assisting shooting. The side plate 2 and the base plate 1 can be provided with multiple interfaces, such as various sizes of threaded holes 16, sliders, cold/hot shoe slots, sliding grooves, and holes, in order to connect with other photography accessories.

In the present invention, the camera can be first fixed to the upper surface of the base plate 1, and then the user can adjust the position of the side plate 2 relative to the base plate 1. Alternatively, the relative position of the side plate 2 and the base plate 1 can be adjusted first, and then the camera can be fixed to the upper surface of the base plate 1. After assembly, the biasing surfaces 422 push against ends of the corresponding sliding components 44, and the other ends of the sliding components 44 pass through the connecting openings 11 to abut against the side plate 2, thereby forming a locked state. That is, the side plate 2 and the base plate 1 are in a locked state, and the side plate 2 and the base plate 1 cannot rotate relative to each other. Thus, the side plate 2 and the base plate 1 can be locked together with a preset angle formed therebetween, such as a preset angle of 0 degree where the side plate 2 is folder over the base plate 1 or a preset angle of 90 degree where the side plate 2 is perpendicular to the base plate 1. By manually pressing or intelligently controlling to drive the locking member 4 to move in the accommodation slot 12 along the rotating axial direction of the side plate 2, the side plate 2 and the base plate 1 is changed from a locked state to an unlocked state. Specifically, the biasing surface releases or loosens the sliding component 44, reducing or eliminating the force that the sliding component 44 applies on the side plate 2. Thus, the side plate 2 is allowed to rotate relative to the base plate 1, transitioning from the locked state to the unlocked state. After the side plate 2 rotates to a preset angle position relative to the base plate 1, the locking member 4 is returned to its original position. The sliding component 44 is pushed against the side plate 2 by the biasing surface of the locking member 4. Thus, the foldable mounting device transitions from the unlocked state back to the locked state in which the side plate 2 is locked with respect to the base plate 1 again, which allows the vertical or horizontal shooting of the auxiliary photographic equipment. The foldable mounting device of the present embodiment has advantages of convenient operation, simple structure, and good user experience. The accommodation slot 12 can be set along the width direction of the base plate 1. Alternatively, the accommodation slot 12 can be set along the length direction of the base plate 1.

In some embodiments, the foldable mounting device further includes a first restoring member 5 which connects the locking member 4 and the base plate 1 and is configured to drive the locking member 4 to return from the unlock position, in which the sliding component 44 is released from the biasing surface of the locking member 4, back to the locked position in which the biasing surface of the locking member 4 abuts against the sliding component 44. The locking member 4 can be pressed manually to move from the locked position to the unlock position.

The first restoring member 5 can be a spring which can be a tension spring or a compression spring. For example, a compression spring is compressed in an end of the accommodation slot 12 away from the slot opening. One end of the compression spring is connected to one end of the locking member 4 away from the slot opening, and the other end of the compression spring abuts against the end wall of the accommodation slot 12. When the locking member 4 is manually pressed, the locking member 4 slides in the accommodation slot 12 from the locked position to the unlocked position to release the sliding component 44, and the compression spring is further compressed. When the operation part 43 is released, the pushing force generated by the compression spring due to being compressed pushes the locking member 4 to return from the unlocked position back to the locked position in which the biasing surface of the locking member 4 biases the sliding component 44, whereby achieving one-click trigger unlocking and automatic locking, with simple and convenient operation. The spring can also be a tension spring, located within the accommodation slot 12 close to the slot opening. During the process of the side plate 2 and the base plate 1 transitioning from the locked state to the unlocked state, the locking member 4 slides in the accommodation slot 12, causing the tension spring to be further stretched. When the operation part 43 is released, the pulling force generated by the tension spring pulls the locking member 4 to return to its original position where the biasing surface of the locking member 4 biases against the sliding component 44.

In some embodiments, the locking member 4 can be driven to move in the accommodation slot 12 by an electric control structure, such as an electric motor. The locking member 4 can also be driven by a driving structure like a threaded rod or a transmission component. For example, a threaded rod is threadedly connected to the base plate 1. The threaded rod can be rotated to drive the locking member 4 to slide in the accommodation slot 12.

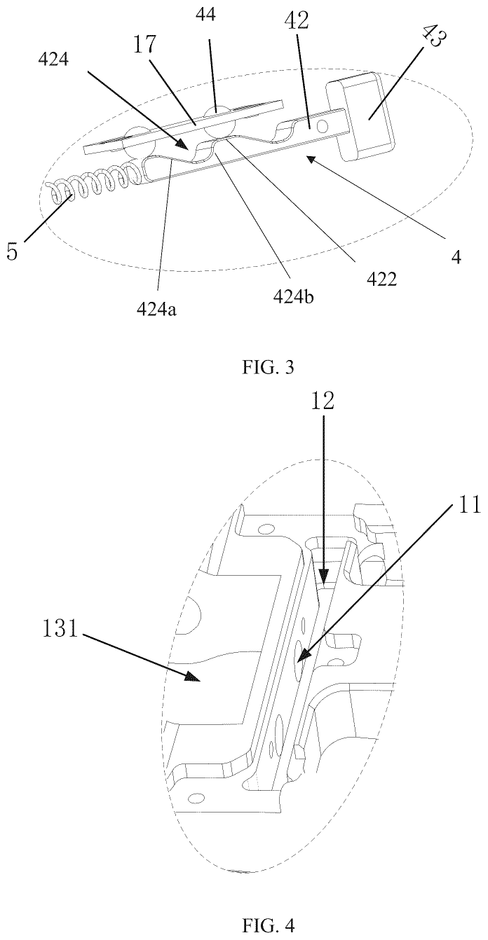

In some embodiments, as shown in FIGS. 2 and 3, the locking member 4 comprises at least one unidirectional recess 424 formed on the side facing the side plate 2. The unidirectional recesses 41 are in one-to-one correspondence with the sliding components 44. Each unidirectional recess 424 has an asymmetrical arc shape. That is, opposite two inclined surfaces 424a/424b forming the recess 424 are asymmetrical. In this embodiment, one of the two inclined surfaces of the recess 424 is longer than the other, and the shorter inclined surface 424b of the unidirectional recess 424 is steeper than the longer inclined surface 424a of the recess 424. The longer inclined surface 424a is closer to the first restoring member 5 than the shorter inclined surface 424b. The longer inclined surface 424a can be named as a guide surface while the shorter inclined surface 424b can be named as a stop surface. In the unlocked state, the sliding components 44 are located in the corresponding arc-shaped recess 424.

In this embodiment, the openings of all unidirectional recesses 41 are oriented in the same direction, facing the sliding components 44. When the locking member 4 is pressed to slide relative to the base plate 1 from the locked state to the unlocked state, all sliding components 44 slide from the biasing surfaces of the locking member 4 to enter the corresponding unidirectional recesses 41 along the longer inclined surfaces of the unidirectional recesses 41. When the sliding components 44 contact the stop surfaces of the corresponding recesses 41, the sliding components 44 stop sliding, thus achieving a unidirectional guidance effect. After all the sliding components 44 enter to the unidirectional recesses 41, the forces that the sliding components 44 act on the side plate 2 reduce or eliminate, allowing the side plate 2 to be rotated to a predetermined position. When the operation part 43 is released, the body 42 is returned to the locked state by the spring 5 such that all sliding components 44 slide along the guiding surfaces of the corresponding recess 424 to the biasing surfaces 422. The sliding components 44 are compressed between the biasing surfaces and the slide plate 2 to thereby apply a biasing force to the side plate 2 to thereby lock the side plate 2 relative to the base plate 1. Thus, a quick conversion between the locked state and the unlocked state of the side plate 2 and the base plate 1 is achieved. The operation is convenient and the structure is simple. In some embodiments, the locking member 4 may also have several protrusions at intervals, forming unidirectional recesses 41 between adjacent protrusions.

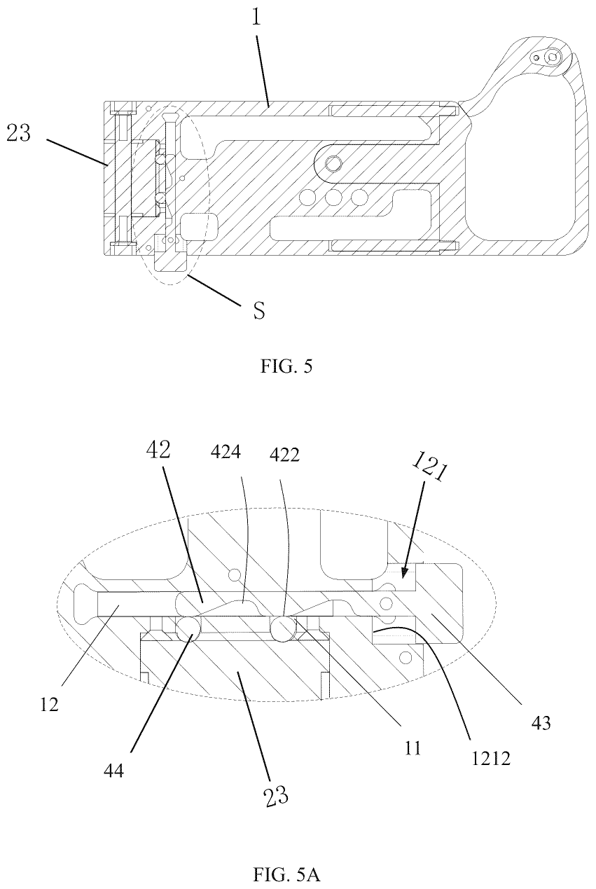

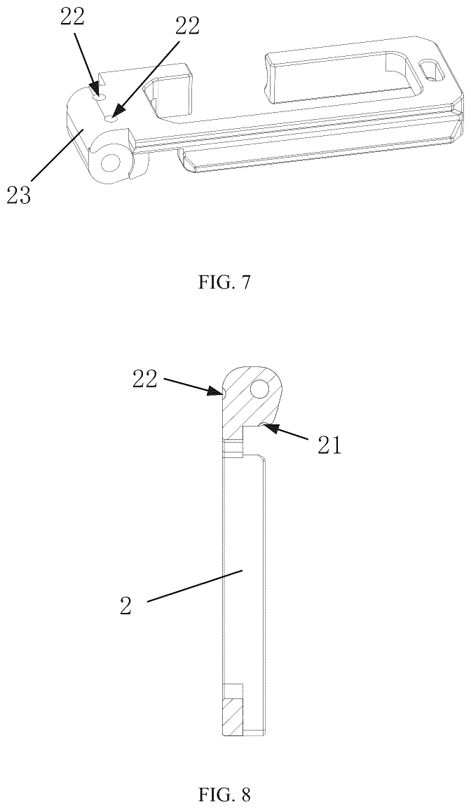

In some embodiments, in order to prevent the side plate 2 from shaking or rotating relative to the base plate 1 during use, as shown in FIGS. 5 to 7, the side plate 2 comprises a rotating connection part 23 that connects to the base plate 1, and the outer wall of the rotating connection part 23 is recessed to form a positioning hole for positioning the sliding component 44.

Further, one end of each of the sliding components 44 abuts against the biasing surface of the locking member 4, and the other end is positioned within the positioning hole, thereby positioning the sliding component 44 and making it more securely fixed between the side plate 2 and the locking member 4. When the side plate 2 is rotated, the other ends of the sliding components 44 slides out of the positioning hole and slides along the surface of the side plate 2, allowing the side plate 2 to rotate relative to the base plate 1 by 270° or more, such as 30°, 90°, 270°, 180°, to meet the needs of use.

In some embodiments, the outer wall of the rotating connection part 23 has multiple positioning holes arranged along the rotation axial direction of the side plate 2, such that the side plate 2 and the base plate 1 can be locked tightly and stably.

In some embodiments, as shown in FIGS. 2 and 3, the sliding component 44 can be a ball, and the inner wall of the positioning hole is arc-shaped to match the shape of the ball. The number of the balls can be one, two, or more, and the balls can be round steel balls. The balls can reduce the friction between the sliding component 44 and the locking member 4/the side plate 2, preventing the sliding component 44 from getting stuck with the locking member 4 or the side plate 2, thus facilitating the relative sliding of the sliding component 44 with respect to the locking member 4 and the side plate 2.

In some embodiments, the connecting opening 11 is a through-hole, and the opening side of the through-hole facing the rotating connection part 23 is contracted. The diameter of the ball is greater than the axial length of the through-hole such that the ball can pass through the through-hole and extend out of the connecting opening 11. One ball is located in one connecting opening 11, and alternatively, one connecting opening 11 can also accommodate two or more balls. The minimum diameter of the contracted part of the opening 11 is less than the diameter of the ball, so that in the locked state, part of the ball extends out of the connecting opening 11. Alternatively, the opening side facing the rotating connection part 23 can also be trumpet-shaped, with the minimum diameter of the trumpet-shaped part being less than the diameter of the ball. The through-hole has a positioning effect on the ball, making the ball better located between the positioning hole and the unidirectional slot, making locking or unlocking accurate and fast, and preventing the ball escaping from the side plate 2 or the base plate 1.

In some embodiments, the sliding component 44 can also be a strip extending along the axial direction of the through-hole, with opposite ends of the strip being arc-shaped or spherical, and the cross-section of the through-hole can be regular or irregular shapes, such as circular, square, rectangular, elliptical, cruciform, etc.

In some embodiments, the foldable mounting device further comprises a positioning plate 17 which is provided at the connecting end of the base plate 1, and the connecting opening is defined in the positioning plate 17. In assembly, the balls can be installed in the connecting openings 11, and then the positioning plate 17 is fixed to the connecting end of the base plate 1, thereby mounting the ball inside the base plate 1. The assembly is convenient, the components are simple to manufacture, and cost-effective. In some embodiments, in order to facilitate manufacturing, one side of the accommodation slot 12 is provided with a baffle that forms the inner wall of the accommodation slot 12. After the locking member 4 is installed in the accommodation slot 12, and the baffle is mounted on one side of the accommodation slot 12.

In some embodiments, to achieve horizontal and vertical shooting of the camera, as shown in FIGS. 5, 7, and 8, the positioning hole includes first positioning holes 21 corresponding to the sliding components 44 and second positioning holes 22 corresponding to the sliding components 44. Both the first positioning holes 21 and the second positioning holes 22 are formed on the outer circumference of the rotating connection part 23. When the sliding components 44 are positioned in the first positioning holes 21, the side plate 2 is folded on the base plate 1. When the sliding components 44 are positioned in the second positioning holes 22, the side plate 2 is set at an angle relative to the base plate 1.

The central angle formed between the first positioning hole 21 and the second positioning hole 22, and the rotation center of the rotating connection part 23 can be 90°. When one end of the sliding component 44 is positioned in the first positioning hole 21 and the other end abuts the locking member 4, the side plate 2 is folded on the base plate 1. When one end of the ball is positioned in the second positioning hole 22 and the other end abuts the biasing surface of the locking member 4, the side plate 2 is perpendicular to the base plate 1. Of course, the central angle formed between the first positioning hole 21, the second positioning hole 22, and the rotation center of the rotating connection part 23 can also be greater than or less than 90°.

During the process of transforming from the folded state in which the side plate 2 is folded on the base plate 1 to an unfolded state in which a preset angle is formed between the side plate 2 and the base plate 1, the locking member 4 is driven to unlock the side plate 2 from the base plate 1, and the side plate 2 is rotated away from the base plate 1, one end of the sliding component 44 slides out of the first positioning hole 21, along the outer circumference of the rotating connection part 23, and into the second positioning hole 22. Then, the locking member 4 resets such that the side plate 2 is locked with respect to the base plate 1. Thus, the side plate 2 is locked with the base plate 1 with the preset angle formed therebetween. Conversely, during the process of transforming from the unfolded state in which the preset angle is formed between the side plate 2 and the base plate 1 to the folded state in which the side plate 2 is folded on the base plate 1, the locking member 4 is driven to unlock the side plate 2 from the base plate 1, and the side plate 2 is then rotated toward the base plate 1, one end of the sliding component 44 slides out of the second positioning hole 22, along the outer circumference of the rotating connection part 23, and into the first positioning hole 21. Then, the locking member 4 resets such that the side plate 2 is locked with respect to the base plate 1. Thus, the side plate 2 is folded on the base plate 1.

In some embodiments, the number for every of the sliding components 44, first positioning holes 21, and second positioning holes 22 is two. The two first positioning holes 21 are spaced apart along the axis of the rotating connection part 23, and the two second positioning holes 22 are also spaced apart along the axis of the rotating connection part 23. The line on which centers of the two first positioning holes 21 are located is parallel to the line on which center of the two second positioning holes 22 are located. The positioning effect is good, and space is saved.

In some embodiments, as shown in FIGS. 2 and 4-5, the connecting end of the base plate 1 is recessed inwardly to form a receiving space 131 that communicates with the connecting opening 11. The rotating connection part 23 is rotatably accommodated in the receiving space 131 via a shaft 6. The connecting end of the base plate 1 comprises two first connecting parts 13 protruding therefrom in a length direction of the base plate 1. The two first connecting parts 13 are located at opposite sides of the receiving space 131 in a width direction of the base plate 1. That is, the receiving space 131 is delimited by the two first connecting parts 13 and a part of the connecting end located between the two first connecting parts 13. The two first connecting parts 13 and the rotating connection part 23 are sleeved on the shaft 6 such that the rotating connection part 23 is rotatable about the axis of the shaft 6 relative to the first connecting parts 13. The rotating connection part 23 is located between the two first connecting parts 13 which cooperatively restrict the movement of the rotating connection part 23 in the width direction of the base plate 1. Thus, a stable connection is formed between the side plate 2 and the base plate 1.

In some embodiments, the rotating connection part 23 is substantially eccentric cylindrical. When the side plate 2 and the base plate 1 are set at 90˜180 degrees from each other, the side of the rotating connection part 23 with the first positioning openings 21 protrudes out of the receiving space 131. When the side plate 2 is rotated to overlap on the side plate 1, the side of the rotating connection part 23 with the first positioning openings 21 is located in the receiving space 131 while the another side of the rotating connection part 23 with the second positioning opening 22 protrudes out of the receiving space 131. On the same cross section passing through the first positioning opening 21 and the second positioning opening 22, the distances from the axis of the shaft 6 to the first positioning opening 21 and the second positioning opening 22 are equal. The side plate 2 and the base plate 1 can rotate relative to each other via the shaft 6. The shaft 6 can be integrally formed with the side plate 2 as an integral structure or can be separately formed from the side plate 2. For example, the rotating connection part 23 has shafts 6 integrally protruding from opposite sides thereof, the first connecting part 13 has corresponding slots for receiving the shafts 6, or the first connecting part 13 has one shaft 6 protruding on one side thereof, the rotating connection part 23 has a corresponding hole for receiving the shaft 6, or both the rotating connection part 23 and the first connecting part 13 have holes, and both the rotating connection part 23 and the first connecting part 13 are sleeved on the shaft 6 via the shaft 6 extending into the holes.

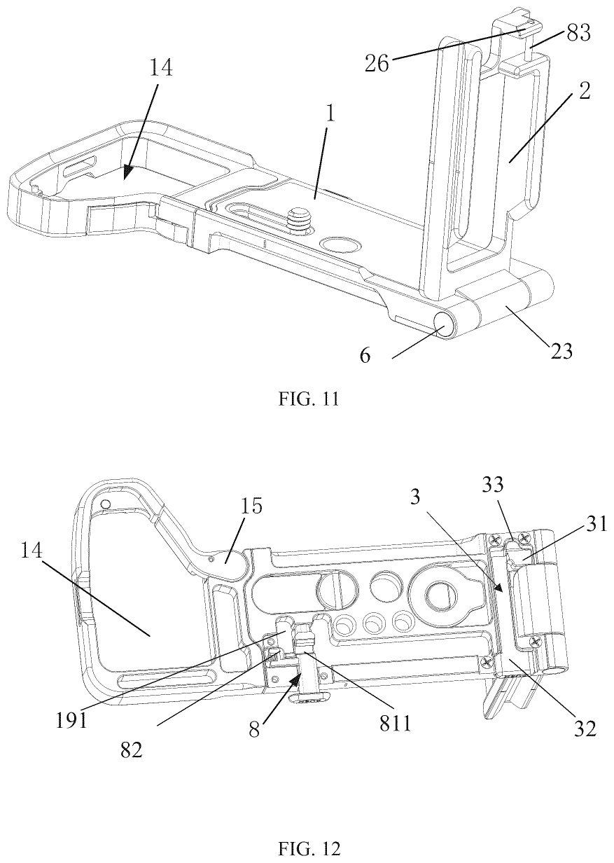

In some embodiments, as shown in FIGS. 1 and 2, the side plate 2 has first inclined side edges 24 on opposite sides of one surface and second inclined side edges 25 on opposite sides of the other surface. The first inclined side edges 24 form a pair of wings and the second inclined side edges 25 form another pair of wings. The first and second inclined side edges 24/25 are configured to selectively engage with the holding components of the photographic equipment. When the side plate 2 is substantially perpendicular to the base plate 1, the first inclined side edges 24 and the second inclined side edges 25 are located above the upper surface of the base plate 1 and perpendicular to the base plate 1, and a holding device can engage with the two second inclined side edges 25 such that the camera hold by the holding device can shoot vertically. When the side plate 2 is overlapped on the base plate 1, the length directions of the first inclined side edges 24 and the second inclined side edges 25 are parallel with the base plate 1, the two second inclined side edges 25 are close to the lower surface of the base plate 1, and the holding device can engage with the two first inclined side edges 24 such that the camera hold by the holding device can shoot horizontally. The first and second inclined side edges 24 and 25 on the same side of the side plate 2 form a V-shaped or trapezoidal groove 245 therebetween. The two first inclined side edges 24 cooperatively form a swallowtail shape, which facilitates to engage with the holding device firmly. The base plate 1 further comprises a sliding part arranged on an end opposite to the connecting end. The sliding part defines a battery receiving chamber 14 (see FIGS. 11-12). The battery receiving chamber 14 has a width greater than that of the connecting end. The side wall of the battery receiving chamber 14 forms a handle 15 (see FIG. 12) for facilitating operation.

In some embodiments, the lower surface of the base plate 1 have third inclined side edges formed on opposite sides thereof. The third inclined side edges are configured to engage with the holding device of the camera which has no flip screen. For example, the holding device of the camera is engaged with the two third inclined side edges, and the side plate 2 and the base plate 1 are perpendicular to each other or at a preset angle. The camera hold on the holding device can shoot horizontally.

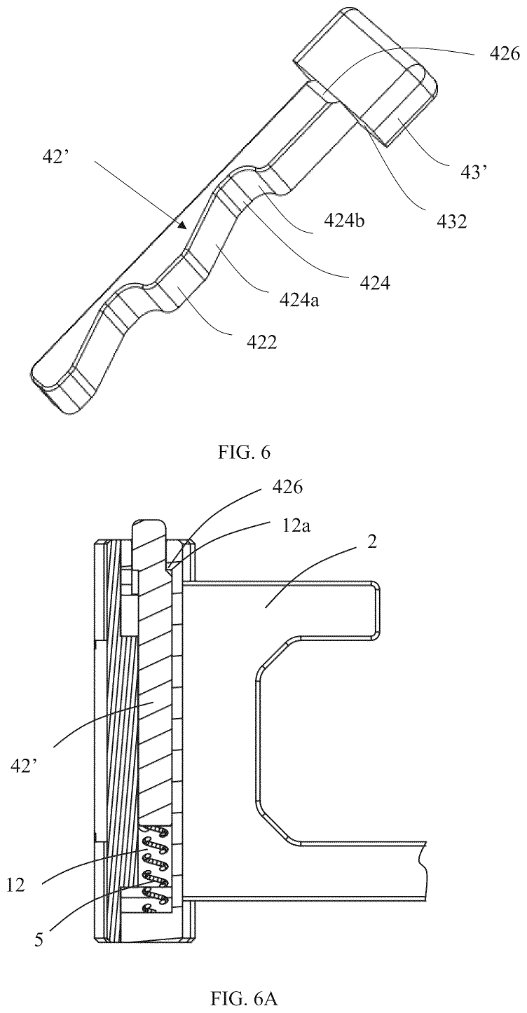

Furthermore, as shown in FIGS. 2 and 3, the body 42 has an elongated strip shape. One end of the body 42 away from the operation part 43 is connected to one end of the first restoring member 5. As shown in FIGS. 6 and 6A, the body 42 has a first positioning end 426, and the operation part 43 has a second positioning end 432. The step formed at a joint between the operation part 43 and the elongated body 42 can act as the second positioning end 432. The slot opening 121 communicates one end of the accommodation slot 12 with outside the base plate 1. The body 42 is slidably accommodated in the accommodation slot 12, and the operation part 43 is partly located in the slot opening 121 with the free end of the operation part 43 located outside the slot opening 121. The first positioning end 426 of the body 42 and the end wall 12a of the accommodation slot 12 cooperatively form a limiting structure for limiting an outwardly moving range of the operation part 43. The second positioning end 432 of the operation part 43 and the end wall 1212 of the slot opening 121 cooperatively form another limiting structure for limiting an inwardly moving range of the operation part 43. When the first positioning end 426 of the body 42 abuts against the end wall 12a of the accommodation slot 12, the second positioning end 432 of the operation part 43 is separated from the end wall 1212 of the slot opening 121. When the second positioning end 432 of the operation part 43 abuts against the end wall 1212 of the slot opening 121, the first positioning end 426 of the body 42 is separated from the slot wall 12a of the accommodation slot 12.

Specifically, the positioning end can be formed on the outer surface, for example the lower surface, of the body 42 in a convex or concave manner, and the lower slot wall of the accommodation slot 12 has a blocking structure formed in a concave or convex manner. The blocking structure is configured to engage with the positioning end, thereby blocking the body 42 from escaping the accommodation slot 12. The positioning end can be formed on the outer surface of the operation part 43 in a convex or concave manner, and the slot wall of the slot opening 121 has a stop structure formed in a concave or convex manner in order to limit the positioning end's movement in the slot opening 121. When the operation part 43 is pressed inwardly, the body 42 will be driven to slide inwardly in the accommodation slot 12. When the operation part 43 approaches or abuts against the slot wall of the slot opening 121, the side plate 2 and the base plate 1 are unlocked, and the first restoring member 5 is deformed. The slot wall of the slot opening 121 can prevent the operation part 43 from sliding excessively. When the operation part 43 is released, the deformed first restoring member 5 generates a restoring force to push the body 42 to slide outward, and the operation part 43 moves away from the slot wall of the slot opening 121 until the positioning end engages with the blocking structure. The positioning end can be formed at the part of the body 42 located in the slot opening 121 or at the part of the body 42 located in the accommodation slot 12.

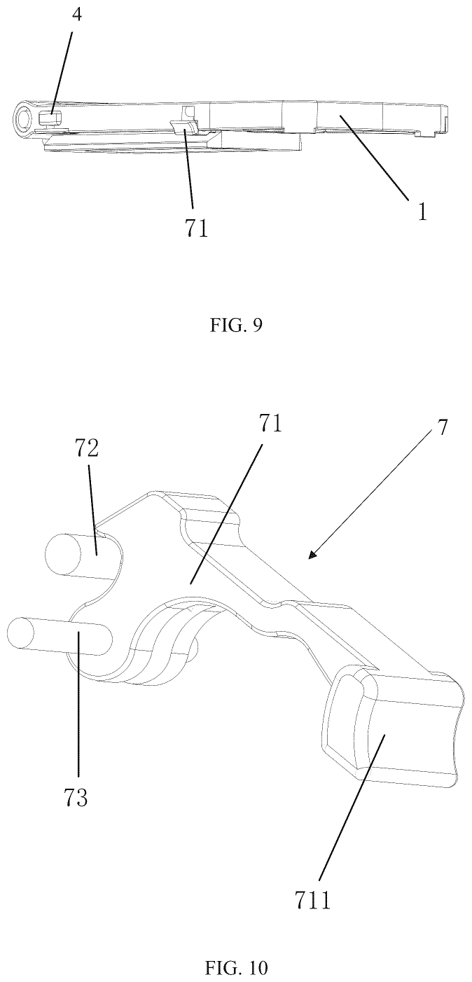

In order to keep the folded side plate 2 and base plate 1 stable, as shown in FIGS. 9 and 10, the foldable mounting device further includes a retaining member 7 for maintaining the free end of the side plate 2 on the base plate 1. The retaining member 7 includes a hook 71, a locking rod 72, and a spring (not shown). The hook 71 is configured to hold the locking rod 72, and the hook 71 is rotatable around the axis of the pivot rod 73 to change its orientation. The spring is sleeved on the pivot rod 73 in order to restore the hook 71. When the locking rod 72 is retained by the hook 71, the side plate 2 is folded on the base plate 1.

Further, for easy operation, the end of the hook 71 away from the pivot rod 73 acts as an operation part 711 which is located on the outside of the side plate 2 or the base plate 1. The surface of the operation part 711 is arc-shaped, facilitating manual operation. The hook 71 is pivotably connected to the base plate 1 by the pivot rod 73, and the locking rod 72 is provided on the side plate 2, making the overall structure simple and compact. Of course, the hook 71 can be pivotably connected to the side plate 2 by the pivot rod 73, and the locking rod 72 can be provided on the base plate 1.

In summary, the side plate 2 is rotatable relative to the base plate 1 from the unfolded state in which a preset angle such as 90 degree is formed between the side plate 2 and the base plate 1 to the folded state in which the side plate 2 is folded on the base plate 1 such that the camera mounted on the mounting device can shoot horizontally. Specifically, the operation part 43 is pressed inwardly to drive the body 42 to slide in the accommodation slot 12 until the operation part 43 is close to or in contact with the slot wall of the slot opening 121, the spring 5 is compressed and the positioning end of the body 42 is separated from the blocking structure. All the balls slide into the corresponding unidirectional recesses 41 from the biasing surface of the locking member 4, and the ends of the balls protruding out of the recesses 41 disengages from the corresponding second positioning openings 22 or the biasing forces of the balls acting on the second positioning openings 22 reduce. The side plate 2 is then rotated relative to the base plate 1 until the side plate 2 is folded over the base plate 1, the operation part 43 is released, the restoring force generated by the spring 5 drives the body 42 to slide outward until the positioning end engages with the blocking structure of the accommodation slot 12. The operation part 43 is moved away from the slot wall of the slot opening 121, all the balls 3 slide along the guide slot surface of the corresponding unidirectional recess 424 to the corresponding biasing surfaces, and the clamping or biasing forces acting on the balls are increased such that the balls 3 are tightly clamped between the biasing surfaces of the locking member 4 and the side plate 2. At the same time, the locking rod 72 slides into the first catching groove 712 along the outer surface of the card hook 71, whereby the side plate 2 being fixed relative to the base plate 1. The holding device of the camera can engage with the two first inclined side edges 24 such that the camera can shoot horizontally. Similarly, the side plate 2 can be rotated from the folded state to the unfolded state such that the camera can shoot vertically. The operation part 711 can be pressed to cause the hook 71 to rotate around the axis of the pivot rod 73 until the locking rod 72 is disengaged from the first catching groove 712 of the hook 71. The operation part 43 is then pressed to unlock the rotating connection part 23 from the locking member 4. After the side plate 2 is rotated to a vertical position relative to the base plate 1, the operation part 43 is released to allow the rotating connection part 23 to be locked by the locking member 4. The holding device of the camera can engage with the two second inclined side edges 25 such that the camera can shoot vertically.

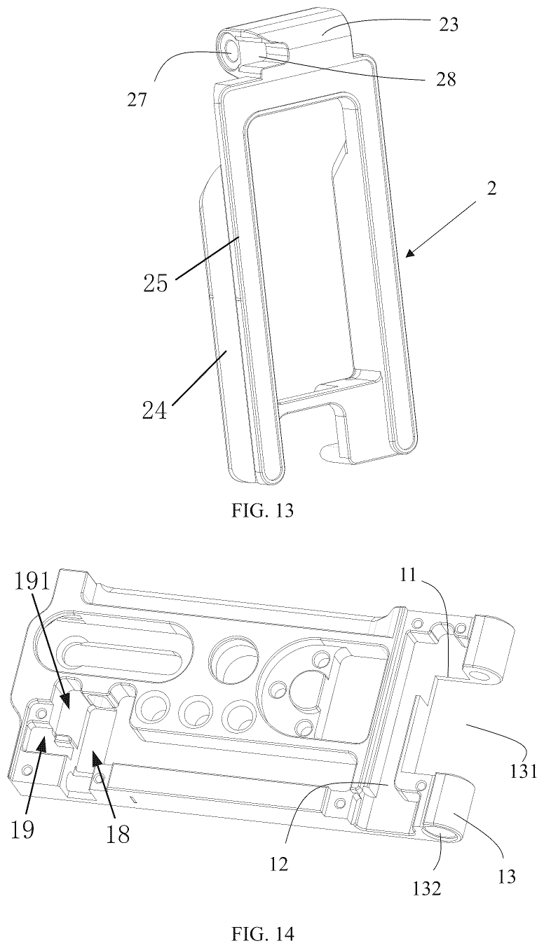

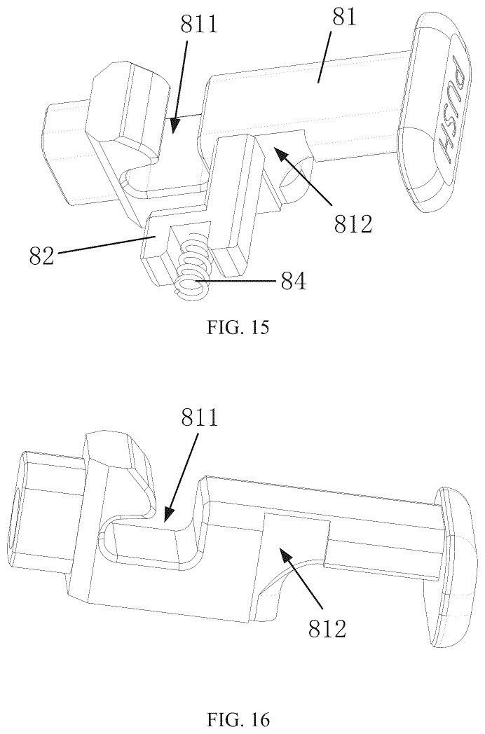

In other embodiments, the retaining member can also be of other structures, such as a specific locking hook structure. To ensure the stability of the foldable mounting device during use in the folded state, as shown in FIGS. 11 to 16, the locking hook structure 8 includes a hook member 81, an engaging member 82, and a locking rod 83. The hook member 81 and the engaging member 82 are both movably connected to the base plate 1. The engaging member 82 is configured to engage with the hook member 81 such that the hook member 81 has an initial position and a holding position. The hook member 81 has a hook groove 811 with a groove opening and a groove end. Preferably, the groove opening and the groove end cooperatively form an L shape. The groove end acts as a locking hook. The position of the groove opening of the hook groove 811 when the hook member 81 is in the initial position is different from the position of the groove opening of the hook groove 811 when the hook member 81 is in the holding position. The side plate 2 has a locking rod 83 which can be engaged in or disengaged from the hook groove 811.

When the engaging member 82 engages with the hook member 81 to maintain the hook member 81 in the initial position, the side plate 2 can be rotated to cause the locking rod 83 to enter in the hook groove 811 from the groove opening of the hook groove 811. After the engaging member 82 releases the hook member 81 and the hook member 81 moves to the holding position, the groove opening of the hook groove 811 is offset from the locking rod 83, thus allowing the locking rod 83 to be engaged in the groove end of the hook groove 811. In the holding position, the locking rod 83 can be engaged with the inner wall of the hook groove 811 around the groove end, making the side plate 2 tightly locked with the base plate 1 such that the foldable mounting device has a stable locked state without any play during the process of use.

Furthermore, as shown in FIGS. 11 to 13, the base plate 1 has a first receiving slot 18 and a second receiving slot 19 communicating with each other on the bottom surface. The hook member 81 is slidably accommodated in the first receiving slot 18, and the engaging member 82 is slidably accommodated in the second receiving slot 19. One end of the hook member 81 is located outside the base plate 1 for facilitating operation. The sliding directions of the hook member 81 and the engaging member 82 are different. One end of the engaging member 82 engages with or abuts against one side of the hook member 81 facing the engaging member 82.

The base plate 1 further comprises an accommodation slot 12 extending along the width direction thereof, and a connecting opening 11 communicating the accommodation slot 12 and the receiving space 131. The rotating connection part 23 of the side plate 2 defines a through hole 27 for receiving a shaft 6 and a positioning opening 28. In this embodiment, the positioning opening 28 is a V-shaped opening defined at an axial end of the rotating connection part 23. The side plate 2 is rotatably connected to the connecting end of the base plate 1 via the rotating connection 23 being received in the receiving space 131 and the shaft 6 passing through the through hole 27 of the side plate 2 and the holes 132 of the two first connecting parts 13 of the base plate 1. In the locked state, the locking member 3 is received in the accommodation slot 12 of the base plate 1 and the locking part 31 of the locking member 3 passes through the connecting opening 11 to be engaged in the positioning opening 28 of the side plate 2 such that the side plate 2 is locked and cannot be rotated relative to the bae plate 1. When the operation part 32 of the locking member 3 is pushed inwardly to make the locking part 31 to disengage from the positioning opening 28 of the side plate 2, the side plate 2 is changed to the unlocked state in which the side plate 2 can be rotated about the axis of the shaft 6 relative to the base plate 1. A restoring member 33 is arranged between the locking member 3 and the base plate 1 and is configured to drive the locking member 3 to return from the unlock position to the locked state. In this embodiment, the restoring member 33 is a C-shaped elastic plate arranged between the locking part 31 and an end wall of the accommodation slot 12.

Preferably, the moving/sliding directions of the hook member 81 and the engaging member 82 are perpendicular to each other. When the hook member 81 is in the initial position, one end of the engaging member 82 engages with the side of the hook member 81. When the hook member 81 is in the holding position, one end of the engaging member 82 abuts against the side of the hook member 81.

Furthermore, for facilitating operation and control, the locking hook structure 8 further includes a second restoring member and a third restoring member 84. The second restoring member is configured to drive the hook member 81 to restore to the holding position and make the locking rod 83 be tightly engaged with the inner wall of the hook groove 811, and the third restoring member 84 is configured to drive the engaging member 82 to engage with the hook member 81. The second restoring member is connected to the hook member 81 and the inner wall of the first receiving slot 18, and the third restoring member 84 is connected to the engaging member 82 and the inner wall of the second receiving slot 19. The second restoring member and the third restoring member 84 can have similar structure, for example both being coiled springs.

When the hook member 81 is in the initial position, the third restoring member 84 urges the engaging member 82 to make one end of the engaging member 82 be engaged with the side of the hook member 81. When the engaging member 82 is operated to release or free the hook member 81, the second restoring member drives the hook member 81 to move to the holding position. After the engaging member 82 is released, the third restoring member 84 drives the engaging member 82 to make one end of the engaging member 82 abut against the side of the hook member 81. When the hook member 81 is in the holding position, one end of the engaging member 82 abuts against the side of the hook member 81.

In some embodiments, as shown in FIG. 16, the side of the hook member 81 facing the engaging member 82 is concave to form a positioning opening 812. When the third restoring member 84 drives one end of the engaging member 82 to engage with the positioning opening 812, the hook member 81 is in the initial position, and the side plate 2 can be rotated to cause the locking rod 83 to enter the hook groove 811.

In some embodiments, as shown in FIG. 11, the engaging member 82 can be manually operated. However, in order to make the operation simpler and more convenient, the side plate 2 has a pushing part 26, and the base plate 1 has a third receiving slot 191 for accommodating the pushing part 26. The third receiving slot 191 communicates with the first receiving slot 18, the second receiving slot 19, and the hook groove 811. When the hook member 81 is in the initial position, the engaging member 82 partially extends into the third receiving slot 191. When the locking rod 83 enters the hook groove 811, the pushing part 26 enter into the third receiving slot 191 to push the engaging member 82 to move in a direction away from the hook member 81 such that the end of the engaging member 82 is disengaged from the positioning opening 812.

When the third restoring member 84 drives one end of the card engaging member 82 to engage with the positioning opening 812, the hook member 81 is in the initial position. When the side plate 2 is rotated to drive the locking rod 83 to enter into the hook groove 811, the pushing part 26 gradually pushes the engaging member 82 in a direction away from the hook member 81 to enter into the second receiving slot 19, which makes one end of the engaging member 82 to gradually disengage from the positioning opening 812. Then, the second restoring member drives the hook member 81 to return to the holding position in which the locking rod 83 is engaged in the hook groove 811. When the side plate 2 is needed to be unlocked, the hook member 81 can be manually pressed to drive the hook member 81 to move to the initial position where the groove opening the hook groove 811 is aligned with the locking rod 83 of the side plate 2. The side plate 2 can then be rotated to make the rod 83 move out from the groove opening of the hook groove 811, the third restoring member 84 drives the engaging member 82 to make one end of the engaging member 82 to slide along the side of the hook member 81 until it is engaged in the positioning opening 812, and the engaging member 82 partially extends into the third receiving slot 191.

In some embodiments, for the convenience of disassembly and processing, the foldable mounting device further includes a cover plate that covers the first receiving slot 18 and the second receiving slot 19, while the slot opening of the second hook slot 811 is exposed on the outer side of the base plate 1.

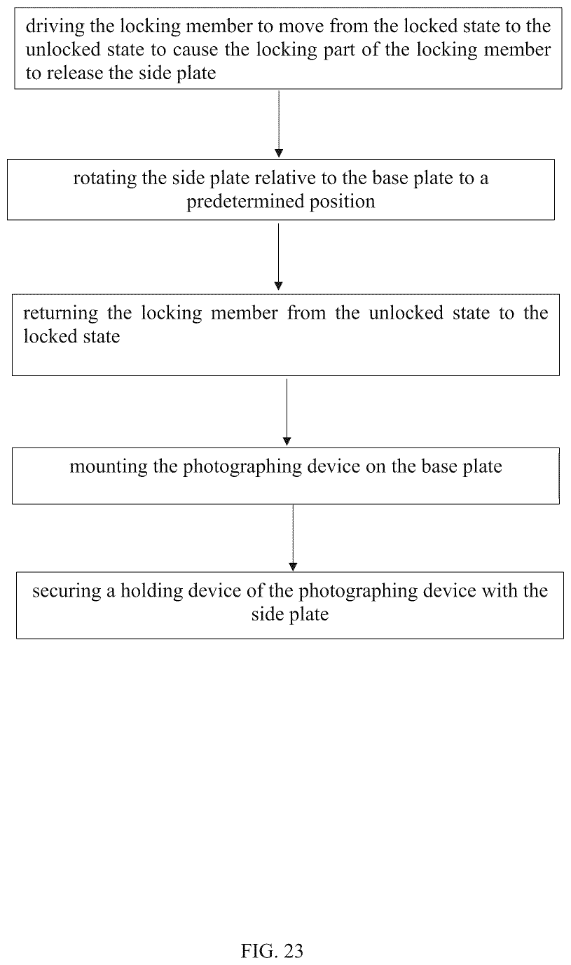

Referring to FIG. 23, the present invention further provides a method of operating the above-described foldable mounting device. After assembly, the foldable mounting device is in a locked state. In the locked state, the biasing surface presses against the sliding components 44 which passes through the connecting opening 11 to push against the side plate 2. The locking member 4 can be driven to move in the accommodation slot 12 from the locked state to the unlocked state to cause the locking part of the locking member to release the side plate 2, i.e., the sliding component 44 being released from the side plate 2 and the locking member 4. The side plate 2 can then be rotated to a desired position in which a preset angle is formed between the base plate 1 and the side plate 2. Then, the locking member 4 is returned from the unlocked state to the locked state such that the foldable mounting device returns to the locked state. The photographic equipment such as a camera can then be mounted on the base plate 1 via a fastening member. The holding device of the photographing device can selectively engage with one of two side surfaces of the side plate 2 such that the photographic equipment can shoot horizontally or vertically.

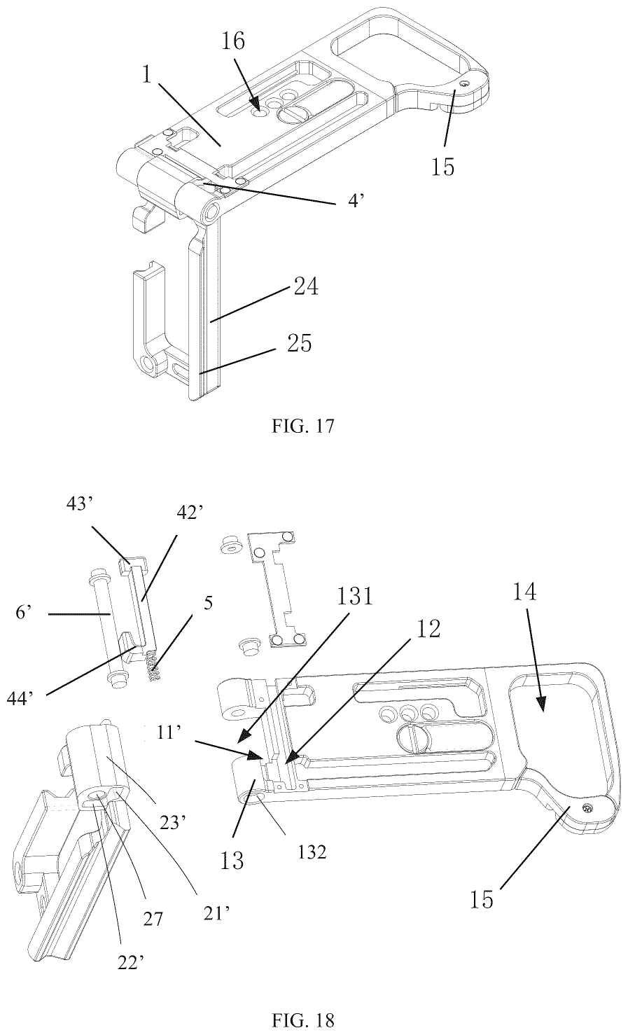

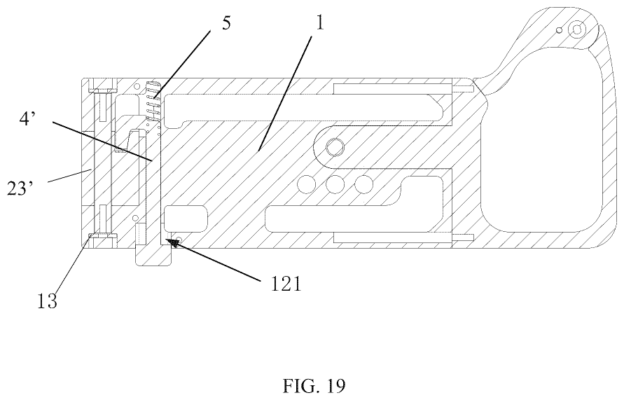

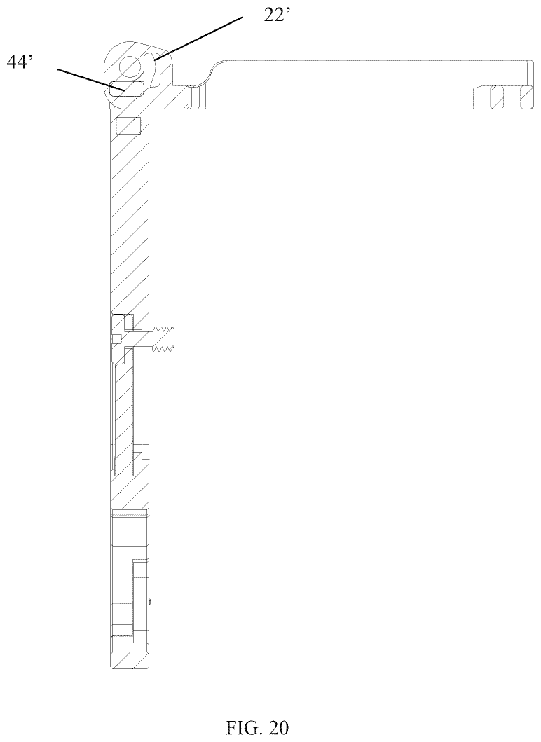

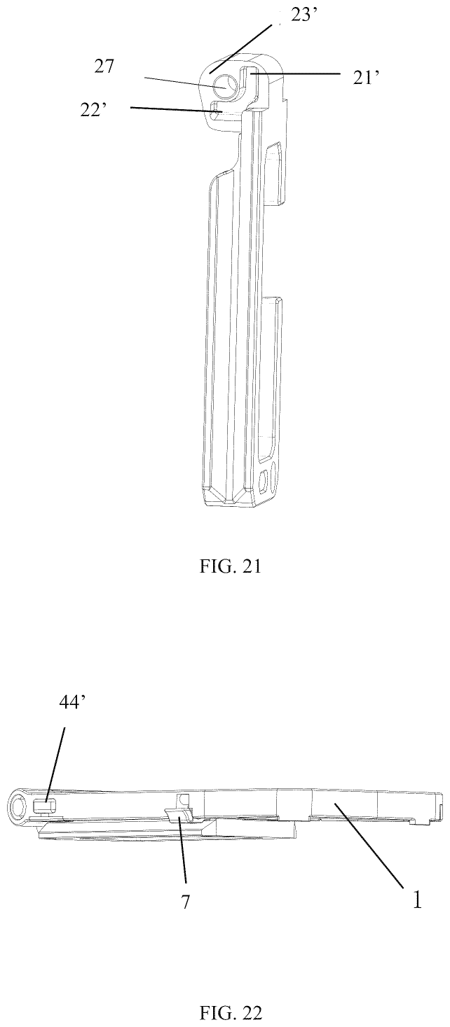

FIGS. 17-22 illustrate a foldable mounting device in accordance with an alternative embodiment of the present invention. In the alternative embodiment, the base plate 1 and the side plate 2 have similar structure as that of the above-described embodiment. The locking member 4′ of the alternative embodiment differs from the locking member of the above-described embodiment in the following aspects:

The locking member 4′ comprises a locking part 44′. The side plate 2 defines at least one positioning opening 21′/22′. The side plate 2 is rotatably connected to the connecting end of the base plate 1 via a shaft 6′ which is received in the hole 27 of the rotation connecting portion 23′ of the side plate 2 and the holes 132 of the two first connecting parts 13 of the base plate 1. In the locked state, the locking member 4′ is received in the accommodation slot 12 and the locking part 44′ passes through the connecting opening 11′ to be engaged in one of the positioning openings 21′/22′ of the side plate 2 such that the side plate 2 is locked and cannot be rotated relative to the bac plate 1. In the unlocked state, the locking part 44′ is disengaged from the locking opening 21′/22′ of the side plate 2 such that the side plate 2 can be rotated about the axis of the shaft 6 relative to the base plate 1. The locking member 4′ is slidably received in the accommodation slot 12 and can be pressed to move from the locked state to the unlocked state and returned from the unlocked state to the locked state by the spring 5 which is compressed between the locking member 4′ and the base plate 1. The side plate 2 comprises a rotating connection part 23′ in which the positioning openings 21′/22′ are defined. In this embodiment, the side plate 2 defines two positioning openings 21′/22′ each of which corresponds to a rotation angle of the side plate 2 relative to the base plate 1. For example, the two positioning openings 21′/22′ are communicated with and perpendicular to each other. When the locking part 44′ is engaged in the first positioning opening 21′, the side plate 2 being locked with respect to the base plate 1 is perpendicular to the base plate 1. When the locking part 44′ is engaged in the second positioning opening 22′, the side plate 2 being locked with respect to the base plate 1 is folded on the base plate 1. In this embodiment, the two positioning openings 21′/22′ are joined together via an arc part. Alternatively, the side plate 2 may define other number of positioning openings such that the side plate 2 can be locked at multiple different angles with respect to the base plate 1.

In this embodiment, the locking part 44′ has a non-circular configuration such that the side plate 2 is nonrotatable about the locking part 44′. Preferably, the locking part 44′ has a conical free end for facilitating to be inserted into the positioning openings 21′/22′.

The locking member 4′ further comprises an elongated strip-shaped body 42′ and an operation part 43′ which is formed at an end of the body 42′ opposite to the locking part 44′.

In this embodiment, the foldable mounting device further includes a retaining member 7 for maintaining the free end of the side plate 2 on the base plate 1. The retaining member 7 has a structure similar to that of the retaining member 7 in the above-described embodiment. The working principle of the retaining member 7 is similar to that of the retaining member 7 in the above-described embodiment.

The above embodiments are merely illustrative or preferred ones of the invention, and neither the text description nor the drawings should be construed as limitations of the protection scope of the invention. Based on the concept as the invention, all equivalent structural transformations made according to the description and drawings, or direct/indirection applications to other related fields should fall within the protection scope of the invention.

What is claimed is:

1. A foldable mounting device applicable for a photographing device, the foldable mounting device comprising:
a base plate comprising a connecting end which comprises an accommodation slot and a connecting opening in communication with the accommodation slot, the accommodation slot comprising a slot opening which passes through a side of the base plate;
a side plate connected to the connecting end of the base plate; and
a locking member slidably received in the accommodation slot, the locking member comprising a locking part and an operation part, the operation part being received in the slot opening and exposed from the side of the base plate;
wherein the locking member is operatable via the operation part to move from a locked state in which the locking part passes through the connecting opening to engage with the side plate such that the side plate is locked and nonrotatable relative to the base plate to an unlocked state in which the locking part is disengaged from the side plate such that the side plate is rotatable relative to the base plate.

2. The foldable mounting device according to claim 1, wherein the foldable mounting device further comprises a restoring member which is connected between the locking member and the base plate and configured to return the locking member from the unlocked state to the locked state.

3. The foldable mounting device according to claim 2, wherein the restoring member is a C-shaped elastic plate arranged between an end wall of the accommodation slot and an end of the locking part.

4. The foldable mounting device according to claim 2, wherein the connecting end of the side plate further comprises a receiving space in communication with the connecting opening;
the side plate comprises a rotating connection part rotatably received in the receiving space; and
the rotation connecting part comprises at least one positioning opening for engaging with the locking part when the locking member is located in the locked state.

5. The foldable mounting device according to claim 1, further comprising a retaining member configured for maintaining the side plate being overlapped on the base plate and blocking the side plate from moving from a folded position to an unfolded position randomly.

6. The foldable mounting device according to claim 5, wherein a free end of the side plate comprises a locking rod;
the retaining member comprises a hook member and an engaging member which are both movably connected to the base plate;
the hook member comprises a hook groove with a groove opening, the hook member being moveable between an initial position and a holding position;
when the engaging member engages with the hook member to maintain the hook member in the initial position, the side plate can be rotated to cause the locking rod to enter in the hook groove from the groove opening of the hook groove; and
after the engaging member releases the hook member to allow the hook member to move to the holding position, the groove opening of the second groove is offset from the locking rod, whereby the locking rod being locked in the hook groove.

7. The foldable mounting device according to claim 6, wherein the base plate comprises a first receiving slot and a second receiving slot defined in a bottom surface thereof, the first receiving slot and the second receiving slot being in communication with each other;
the hook member is slidably received in the first receiving slot, and the engaging member is slidably received in the second receiving slot;
one end of the hook member is located outside the base plate for facilitating operation; and
the sliding directions of the hook member and the engaging member are different from each other.

8. The foldable mounting device according to claim 7, wherein the hook member comprises a positioning opening defined at a side thereof facing the engaging member;
the side plate comprises a pushing part, and the base plate comprises a third receiving slot communicating with the first receiving slot and the second receiving slot;
when the hook member is in the initial position, the engaging member partially extends into the third receiving slot and an end of the engaging member is engaged in the positioning opening; and
when the locking rod enters the hook groove, the pushing part enters the third receiving slot to push the engaging member to move in a direction away from the hook member such that the end of the engaging member is disengaged from the positioning opening.

9. The foldable mounting device according to claim 1, wherein the side plate comprises a first pair of wings formed on opposite sides of one surface thereof and a second pair of wings formed on opposite sides of another surface thereof such that a holding device of the photographic equipment can selectively engage with the first pair of wings or the second pair of wings.

10. The foldable mounting device according to claim 4, wherein the locking member further comprises a body which comprises at least one biasing surface and at least one recess formed at a side thereof facing the side plate, the at least one recess comprising a guide surface and a stop surface opposite to the guide surface;
the locking part comprises at least one sliding component which is movably received in the connecting opening and disposed between the side plate and the body of the locking member;
when the locking member is located in the locked state the at least one sliding component is compressed between the side plate and the at least one biasing surface; and
when the locking member is located in the unlocked state the at least one sliding component slides into the at least one recess along the guide surface to disengage from the side plate.

11. The foldable mounting device according to claim 10, wherein the guide surface is longer than the stop surface; or
the stop surface is steeper than the guide surface.

12. The foldable mounting device according to claim 10, wherein the at least one positioning opening comprises multiple positioning holes distributed at interval in a rotation direction of the side plate; or
the at least one positioning opening comprises multiple positioning slots in communication with each other.

13. The foldable mounting device according to claim 10, wherein the locking part comprises at least one ball and the at least one positioning opening comprises multiple positioning holes each of which has a shape matching with the at least one ball.

14. The foldable mounting device according to claim 10, wherein the at least one positioning opening comprises at least one first positioning opening and at least one second positioning opening;
when the locking part is engaged in the at least one first positioning opening, the side plate is located in a folded state in which the side plate is folded on the base plate; and
when the locking part is engaged in the at least one second positioning opening, the side plate is located in an unfolded state in which a preset angle is formed between the side plate and the base plate.

15. The foldable mounting device according to claim 4, wherein the connecting end of the base plate further comprises a pair of first connecting parts located at opposite sides of the receiving space;
the receiving space is spaced from the accommodation slot in a length direction of the base plate;
the connecting opening communicates the receiving space with the accommodation slot;
the locking member is slidable in the accommodation slot in a width direction of the base plate which is perpendicular to the length direction; and
the rotation connecting part and the first connecting parts define aligned holes, and a shaft is received in the aligned holes to thereby pivotably connect the rotation connecting part to the first connecting parts.

16. The foldable mounting device according to claim 15, wherein the locking part is movable in the connecting opening in the length direction; or
the locking part is movable in the connecting opening in the width direction.

17. The foldable mounting device according to claim 2, wherein the locking member further comprises an elongated body, the operation part is located at an end of the elongated body opposite to the restoring member, and a step is formed at a joint between the operation part and the elongated body;
a stop wall is formed at a joint between the accommodation slot and the slot opening for limiting an inwardly moving range of the operation part; and
a limiting structure is formed between the elongated body and the accommodation slot for limiting an outwardly moving range of the operation part.

18. The foldable mounting device according to claim 1, wherein the base plate further comprises a battery receiving chamber formed at an end thereof opposite to the connecting end, and the battery receiving chamber comprises a sidewall which acts as a handle.

19. A method for operating the foldable mounting device according to claim 1, the method comprising:
pushing the locking member from the locked state to the unlocked state to cause the locking part of the locking member to release the side plate;
rotating the side plate relative to the base plate to a predetermined position; and
returning the locking member from the unlocked state to the locked state.

20. The method of claim 19, wherein the method further comprises:
mounting the photographing device on the base plate; and
securing a holding device of the photographing device with the side plate.
